(19) United States
(12) Patent Application Publication
(10) Pub. No.: US 2015/0029834 A1
(43) Pub. Date: Jan. 29, 2015

(54) TRANSMISSION PATH SWITCHING

(71) Applicant: Hangzhou H3C Technologies Co., Ltd., Hangzhou (CN)

(72) Inventors: Haifeng Zhang, Beijing (CN); Changwang Lin, Beijing (CN)

(73) Assignee: Hangzhou H3C Technologies Co., Ltd., Hangzhou (CN)

(21) Appl. No.: 14/372,718

(22) PCT Filed: Feb. 21, 2013
(86) PCT No.: PCT/CN2013/071715

§ 371 Date: Jul. 16, 2014

(30) Foreign Application Priority Data
Apr. 5, 2012 (CN) 201210097672.X

(51) Int. Cl. H04L 12/703; H04L 12/741

(52) U.S. Cl. CPC H04L 45/28; H04L 45/54
USPC 370/225

(57) ABSTRACT

According to an example, a virtual next-hop is created and a destination identity corresponding to each virtual next-hop is stored. Each virtual next-hop comprises one best next-hop and one second-best next-hop, and a next-hop of the best path of the destination identity corresponding to a virtual next-hop is the best next-hop of the virtual next-hop, and a next-hop of the second-best path of the destination identity corresponding to the virtual next-hop is the second-best next-hop of the virtual next-hop. Path forwarding may be performed using the best next-hop of each virtual next-hop. If the best next-hop of a virtual next-hop is determined to be failed, path forwarding may be performed using the second-best next-hop of the virtual next-hop.

### BACKGROUND

In order to implement unicast routing, a protocol layer of a router typically uses a routing protocol, such as Open Shortest Path First (OSPF) routing protocol, Intermediate System to Intermediate System (IS-IS) routing protocol, Border Gateway Protocol (BGP) or Routing Information Protocol (RIP).

### BRIEF DESCRIPTION OF THE DRAWINGS

Features of the present disclosure are illustrated by way of example and not limited in the following figure(s), in which like numerals indicate like elements, in which:

FIGS. 1a to 1b are schematic diagrams illustrating transmission path switching in accordance with an example of the present disclosure;

FIG. 2 is a flow chart illustrating a method for implementing transmission path switching in accordance with an example of the present disclosure;

FIG. 3 is a schematic diagram illustrating structure of a device for implementing transmission path switching in accordance with an example of the present disclosure; and

FIG. 4 is a hardware architecture which may be used for the device shown in FIG. 3.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” to means includes but not limited to, the term “including” means including but not limited to. The term “based on” means based at least in part on. In addition, the terms “a” and “an” are intended to denote at least one of a particular element.

The present disclosure references the accompanying drawings to make the objective, technical solution and merits thereof more apparent.

A protocol layer according to an example of the present disclosure may calculate the best route to a destination address according to the current network topology. The best route to a destination address takes the destination address as a prefix (i.e., a destination identity), and includes a next-hop taking the destination address as an end.

Each prefix and a next-hop of a route for each prefix obtained by the route calculation may be saved in a Routing Information Base (RIB) of a router control plane. After performing route selection for routes in the RIB, each prefix and the next-hop of the best route for each prefix are added in the Forwarding Information Base (FIB) of a forwarding plane. After the route calculation is finished, each prefix and the next-hop of the best route for each prefix saved in the FIB are sent to a hardware layer, by which the path forwarding in a unicast mode is implemented.

After detecting that a link is failed, a new route calculation is triggered if the network topology is changed resulting from the failed link. Accordingly, the next-hop of the best route for each prefix in the FIB is updated. After the new route calculation is finished, each prefix and the updated next-hop of the best route for each prefix in the FIB are sent to the hardware layer one by one for updating.

Furthermore, after a link is failed and the network topology is changed due to the failed link, and before the each prefix and the updated next-hop of the best route for each prefix are sent to the hardware layer, a router continues to perform the path forwarding in the unicast mode according to the original next-hop of the best route for each prefix, resulting in loss of traffic transmitted on the failed link.

A period during which traffic loss occurs is called route convergence time. The route convergence time includes time for detecting the failed link, time for recalculating routes and time for sending and updating routes of all the prefixes. Since each prefix and the updated next-hop of the best route for each prefix is to be sent to the hardware layer, the route convergence time is determined by the number of the prefixes on the premise that the time for detecting the failed link and the time for recalculating the routes is determined. Therefore, the route convergence time increases along with the increase of the number of the prefixes, while the increase of the number of the prefixes results in the increase of the lost traffic.

Similarly, in other technologies such as the Multi-Protocol Label Switching (MPLS), the problem of traffic loss also exists when the transmission path is switched. Furthermore, the lost traffic increases along with the increase of the number of the destination identities, such as the prefixes.

In an example of the present disclosure, the description is given with the transmission path taken as a unicast route and the destination identity taken as the prefix of the unicast route.

First, in an example of the present disclosure, as for each prefix, the best route can be formed with a prefix and the best next-hop, or a second-best route may be formed with the same prefix and a second-best next-hop. The selection process of the RIB of the router control plane not only may select the best route of the prefix, but also may select the second-best route of the prefix.

The best route and second-best route of each prefix may respectively be static routes, or be any kind of the dynamic routes, such as OSPF protocol routes, IS-IS protocol routes, BGP routes and RIP routes.

As for the static route, when the static route selection is performed, besides selecting the best static route for each prefix and configuring the corresponding best next-hop, a second-best static route may be selected and a corresponding second-best next-hop may be configured if each prefix is configured with multiple static routes.

As for the OSPF protocol route in the dynamic routes, when intra-area routes in an Autonomous System (AS) are calculated, besides selecting the best next-hop corresponding to the valid intra-area router best route of each OSPF prefix, it is determined whether a valid intra-area router second-best route of the each OSPF prefix exists. If yes, the second-best next-hop corresponding to the intra-area router second-best route of the each OSPF prefix is selected.

When inter-area routes in the AS are calculated, besides selecting the best next-hop corresponding to a valid Area Border Router (ABR) best route of the each OSPF prefix, it is determined whether a valid ABR second-best route of the each OSPF prefix exists. If yes, a second-best next-hop corresponding to the ABR second-best route of the each OSPF prefix is selected.

When external routes between AS are calculated, besides the best next-hop corresponding to a valid Autonomous System Boundary Router (ASBR) best route of the each OSPF prefix is selected, it is determined whether a valid ASBR second-best route of the each OSPF prefix exists. If yes, the second-best next-hop corresponding to the ASBR second-best route of the each OSPF prefix is selected.

As for the IS-IS protocol route in the dynamic routes, a router of each level of the IS-IS may be regarded as a Shortest Path First (SPF) node. Each SPFnode may publish prefixes with Type-Length-Value (TLV) coding information in an IS-IS protocol packet.

Accordingly, a prefix may be sent from multiple routers, i.e. multiple SPFnodes. The prefix may be called a multi-release source prefix.

As for each IS-IS prefix which is a multi-release source prefix, besides selecting the best SPFnode set corresponding to the IS-IS prefix, one best next-hop is to be found from the best SPFnode set, and the best route is to be formed with the best next-hop and the IS-IS prefix, a second-best SPFnode set corresponding to the IS-IS prefix is to be selected through traversing, and a second-best next-hop is to be found from the second-best SPFnode set, and a second-best route is to be formed with the second-best next-hop and the IS-IS prefix.

As for a BGP route in the dynamic routes, after each route is calculated, the route calculation of the BGP is performed to determine whether the route is better than the best route obtained by the calculation. If yes, the best route is replaced with the route. Therefore, the best route in all the routes is saved after obtaining all the routes through the calculation.

In this example of the present disclosure, after learning each route, the route calculation of the BGP usually determines whether the route is better than the calculated best route and second-best route. If the route is better than the best route, the best route is replaced with the route, and the best route which is replaced with the route is stored as the second-best route. If the route is not better than the best route but better than the second-best route, the second-best route is replaced with the route, and the stored best route is kept. Therefore, the best route and the second-best route in all the routes may be saved after all the routes are obtained.

Therefore, the best next-hop corresponding to the best route and the second-best next-hop corresponding to the second-best route may be obtained.

In addition, the route calculation method of the BGP protocol mainly applies to a situation that the number of the route is one. If the number of the route is larger than one, the situation applies to Equal-Cost route, which is not concerned by this disclosure and is not repeated in this disclosure.

As for a RIP route in the dynamic routes, when multiple ports receive multiple RIP routes with the same prefix, if the multiple RIP routes do not form the Equal-Cost routes, one is selected from the publish source corresponding to the multiple ports and is taken as the best next-hop, and the best route is formed with the best next-hop and the IS-IS prefix. Then, one is selected from other published resources and taken as the second-best next-hop, and the second-best route is formed with the second-best next-hop and the IS-IS prefix.

In addition, the Equal-Cost route related to the RIP route may not be used, and thus is not described.

In an example of the present disclosure, after selecting the next-hop of the best route and the next-hop of the second-best route of each prefix, this example does not simply add the next-hop of the best route and the next-hop of the second-best route of all the routes in the FIB, but creates a virtual next-hop in the FIB according to the next-hop of the best route and the next-hop of the second-best route of all the routes, and records at least one prefix of each virtual next-hop.

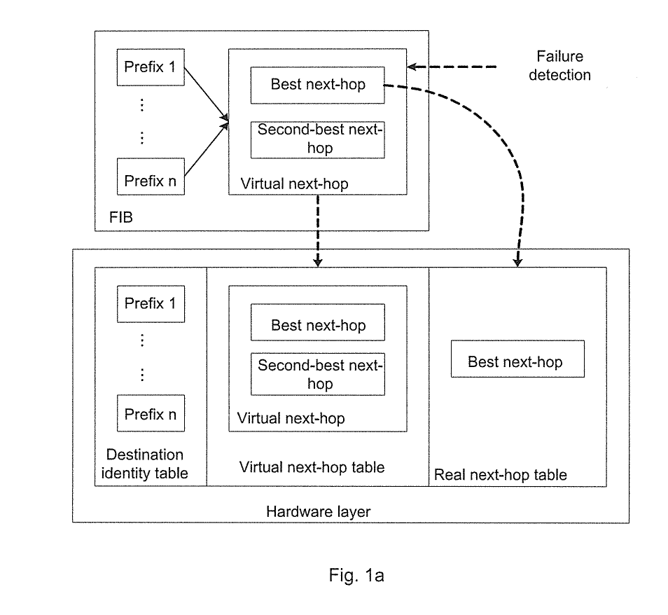

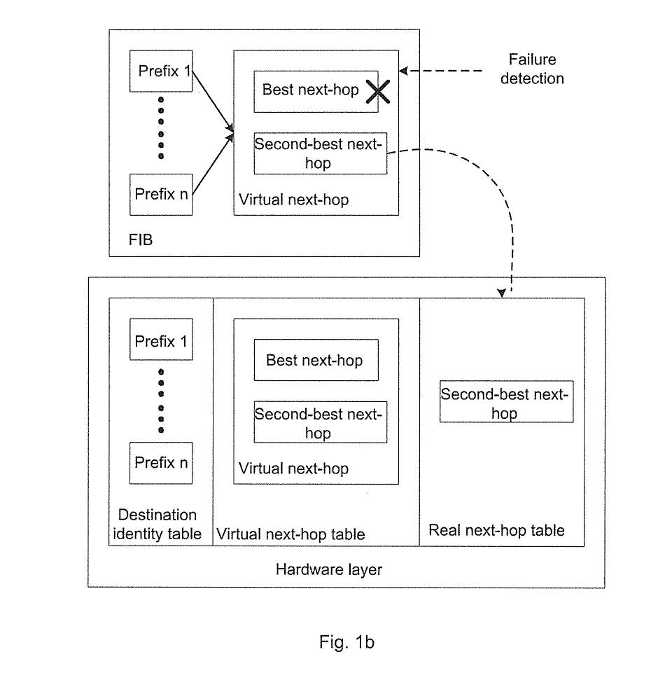

FIGS. 1a to 1b are schematic diagrams illustrating transmission path switching in accordance with an example of the present disclosure.

First, referring to FIGS. 1a and 1b, each virtual next-hop created in the FIB corresponds to at least one prefix 1−n (n is a positive integer). Each virtual next-hop includes one best next-hop and one second-best next-hop. Furthermore, the next-hop of the best route of all the at least one prefix 1−n corresponding to the each virtual next-hop is the best next-hop of the each virtual next-hop, and the next-hop of the second-best route of all the at least one prefix 1−n corresponding to the each virtual next-hop is the second-best next-hop of the virtual next-hop.

For instance, assume that there are prefix 1 and prefix 2. The best route of the prefix 1 is a route 11, and the second-best route of the prefix 1 is a route 12. The best route of the prefix 2 is a route 21, and the second-best route of the prefix 2 is a route 22. As long as the route 11 and the route 21 have the same next-hop, and the route 12 and the route 22 have the same next-hop, the prefix 1 and prefix 2 correspond to the same virtual next-hop, the best next-hop of the virtual next-hop is the common next-hop of the route 11 and the route 21, and the second-best next-hop of the virtual next-hop is the common next-hop of the route 12 and the route 22.

That is, in the example of the present disclosure, all prefixes, in which the best routes have the same next-hop and the second-best routes also have the same next-hop, may use the same virtual next-hop.

Referring again to the FIGS. 1a and 1b, the hardware layer saves a destination identity table, a virtual next-hop table and a real next-hop table.

During the transmission process after finishing the route calculation as shown in figure la, the prefixes 1−n corresponding to each virtual next-hop are sent to the destination identity table in the hardware layer. Each virtual next-hop is sent to the virtual next-hop table in the hardware layer. The best next-hop of each virtual next-hop may be taken as an available next-hop and sent to the real next-hop table in the hardware layer. The second-best next-hop of each virtual next-hop is taken as a backup route.

Furthermore, a corresponding relationship between all the prefixes in the destination identity table of each virtual next-hop in the virtual next-hop table and the best next-hop in the real next-hop table of each virtual next-hop may be established through the virtual next-hop in the virtual next-hop table. The corresponding relationship between the destination identity table and the real next-hop table may be implemented with other modes, instead of the virtual next-hop in the virtual next-hop table. Since the real next-hop table saves the best next-hop of each virtual next-hop, the normal path forwarding may be implemented in the hardware layer according to the best next-hop in the real next-hop table.

Furthermore, after all the routes are sent to the hardware layer, failure detection is to be performed for the best next-hop of each virtual next-hop in the FIB. That is, it is determined whether the best next-hop is available through the detection of the link or the ports.

In actual application, the failure detection may be the Address Resolution Protocol (ARP) detection or Bidirectional Forwarding Detection (BFD) detection.

As for the ARP detection, when any port is changed from Up to Down, the corresponding ARP information is deleted. Accordingly, the link at which the port whose ARP information is deleted locates, is determined as a failed link. While when the state of any port changes from Down to UP, the corresponding ARP information may be learned. Accordingly, the link, at which the port whose ARP information is newly learned locates, is determined as the available link.

As for the BFD detection , when both a port adopting the BFD detection and the peer support the BFD detection, a peer-to-peer relationship may be established between the port adopting the BFD detection and the peer, Control packet is sent between them. If the port adopting the BFD detection does not receive the Control packet of the pre-determined amount in the pre-determined time, the link, at which the port locates, is determined as the failed port. When the peer of the port adopting the BFD detection does not support the BFD detection, the port adopting the BFD detection may send Echo packet to the peer, and receives the Echo packet from the peer. If the port adopting the BFD detection does not receive the Echo packet of the pre-determined amount in the pre-determined time, the link, at which the port locates, is determined as the failed port.

As shown in FIG. 1b, if a link is failed, and if the failed link results in the change of the network topology, it may be detected that the best next-hop of the corresponding virtual next-hop is failed with the failure detection. The second-best next-hop of the virtual next-hop in the FIB may be taken as the available next-hop, and the available next-hop is sent to the real next-hop table in the hardware layer. The best next-hop in the real next-hop table of the virtual next-hop of the hardware layer is replaced with the second-best next-hop of the virtual next-hop. Therefore, contents saved in the real next-hop table may be updated in the hardware layer.

Since the real next-hop table saves the second-best next-hop of the corresponding virtual next-hop, the route switching may be performed for all the prefixes corresponding to the virtual next-hop in the hardware layer according to the second-best next-hop in the real next-hop table. With the above technical scheme, time needed for recalculating the route, and time for sending each prefix and the updated next-hop of the best route for each prefix to the hardware layer one by one is no longer needed, which may recover the traffic as soon as possible and reduce the loss of the traffic.

It can be seen from the above that the convergence time generated in the example of the present disclosure mainly includes time for detecting failed links, and time for sending the virtual next-hop, but does not include time for recalculating routes. Furthermore, in this example of the present disclosure, since the detection time may be reduced through the failure detection, and the time for sending the virtual next-hop is far less than the time for sending all the prefixes and time for sending the updated next-hop of the best route of the prefixes. Therefore, this example of the present disclosure may reduce the affect of the number of the prefixes on the route convergence time, and further reduce the loss of the traffic.

Furthermore, if it is detected that the best next-hop of any virtual next-hop is available through the failure detection, and the newly-triggered route calculation is not finished, the best next-hop of the virtual next-hop in the FIB is sent to the real next-hop table in the hardware layer. Therefore, within the route convergence time, the routes of all the prefixes corresponding to the virtual next-hop are switched to the best next-hop.

For the convenience of distinguishing the function of the best next-hop and the second-best next-hop, a flag denoting that the failure detection is to be performed for the best next-hop may be configured for the best next-hop of each virtual next-hop in the FIB, and a flag denoting that the second-best next-hop is taken as the backup route is configured for the second-best next-hop of each virtual next-hop in the FIB. The flag denoting that the failure is detection is to be performed may further include a type of the failure detection, and is used for distinguishing the type of the detection, such as the ARP detection and the BFD detection.

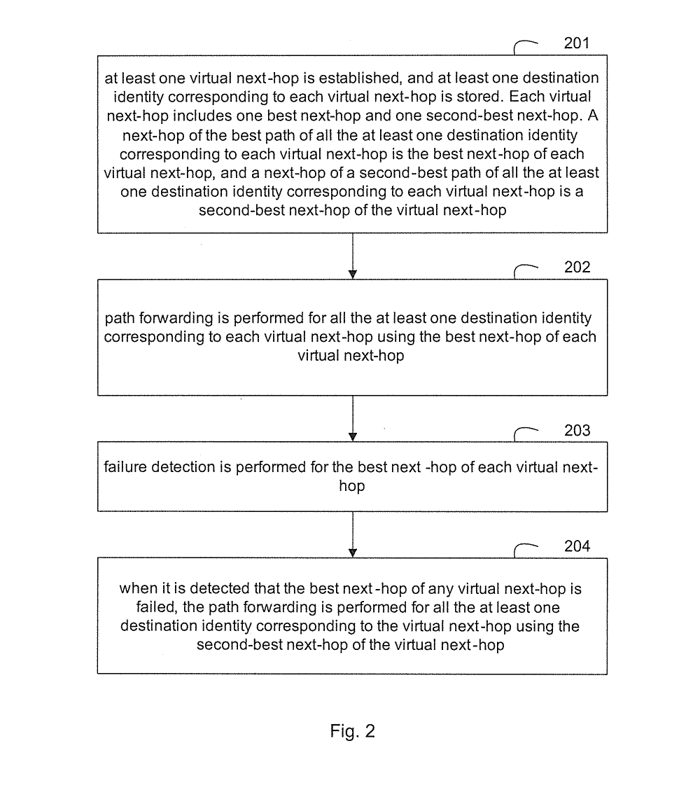

FIG. 2 is a flow chart illustrating a method for implementing transmission path switching in accordance with an example of the present disclosure. As shown in FIG. 2, the method for implementing the transmission path switching takes the switching of the unicast route for example. The method includes the following blocks.

At block 201 at least one virtual next-hop is established, and at least one destination identity corresponding to each virtual next-hop is stored. Each virtual next-hop includes one best next-hop and one second-best next-hop. A next-hop of the best path of all the at least one destination identity corresponding to each virtual next-hop is the best next-hop of each virtual next-hop, and a next-hop of a second-best path of all the at least one destination identity corresponding to each virtual next-hop is a second-best next-hop of the virtual next-hop.

In this block, when the route calculation starts, the virtual next-hop is created in the FIB.

The best route and second-best route in this block may be a route of the OSPF protocol, a route of the IS-IS protocol, or a route of the BGP.

Furthermore, in this block, a flag denoting that failure detection is to be performed for the best next-hop and may further be configured for the best next-hop of each virtual next-hop in the FIB, and a flag denoting that the second-best next-hop is taken as the backup route may further be configured for the second-best next-hop of each virtual next-hop in the FIB.

At block 202 path forwarding is performed for all the at least one destination identity corresponding to each virtual next-hop using the best next-hop of each virtual next-hop.

In this block, when the route calculation is finished, all the at least one destination identity corresponding to each virtual next-hop in the FIB, and is the best next-hop of each virtual next-hop is sent to the hardware layer.

Therefore, the path forwarding may be performed for all the at least one destination identity corresponding to each virtual next-hop in the hardware layer using the best next-hop of each virtual next-hop. In the alternative, all the at least one destination identity corresponding to each virtual next-hop in the FIB, and the best next-hop of each virtual next-hop are saved in a software table. In this way, the CPU may query the software table, and perform the path forwarding for all the at least one destination identity corresponding to each virtual next-hop using the best next-hop of each virtual next-hop.

At block 203 failure detection is performed for the best next-hop of each virtual next-hop.

In this block, when the route calculation is finished, the failure detection is performed for the best next-hop of each virtual next-hop in the FIB. The failure detection may be the ARP detection or BFD detection.

At block 204 when it is detected that the best next-hop of any virtual next-hop is failed, the path forwarding is performed for all the at least one destination identity corresponding to the virtual next-hop using the second-best next-hop of the virtual next-hop.

In block 202, if all the at least one destination identity corresponding to each virtual next-hop in the FIB, and the best next-hop of each virtual next-hop are sent to the hardware layer, the second-best next-hop of each virtual next-hop in the FIB is sent to the hardware layer. Therefore, the switching processing may be performed in the hardware layer, to switch the path from the best next-hop of the virtual next-hop to the second-best next-hop of the next-hop, and perform the path forwarding for all the at least one destination identity corresponding to the virtual next-hop using the second-best next-hop of the virtual next-hop.

In block 202, if all the at least one destination identity corresponding to each virtual next-hop in the FIB, and the best next-hop of each virtual next-hop are sent to the software table, the second-best next-hop of each virtual next-hop in the FIB is sent to the software table. Therefore, the CPU may query the software table, and perform the path forwarding for all the at least one destination identity corresponding to the virtual next-hop using the second-best next-hop of the virtual next-hop.

After the above switching process is finished, if it is detected that the above failed best next-hop of the virtual next-hop becomes the available best next-hop through the failure detection before the newly-triggered route calculation is finished, the best next-hop of the virtual next-hop in the FIB may be sent to the hardware layer. The hardware layer switches the path from the second-best next-hop to the best next-hop and performs the path forwarding for all the at least one destination identity corresponding to the virtual next-hop using the best next-hop of the virtual next-hop. In the alternative, the best next-hop of the virtual next-hop in the FIB is saved in the software table. The CPU switches the route from the second-best next-hop to the best next-hop and performs the path forwarding for all the at least one destination identity corresponding to the virtual next-hop using the best next-hop of the virtual next-hop.

The above method not only applies to the unicast route, but also applies to other technologies such as the MPLS. Accordingly, the route calculation, route forwarding, route switching, route switching-back and destination identities are respectively replaced with the path calculation, path forwarding, path switching, path switching-back and destination identities of other technologies such as the MPLS. In addition, as for the other technologies, such as the MPLS, the FIB may be replaced with corresponding media.

In the above description, all the destination identities corresponding to each virtual next-hop may be all the prefixes corresponding to each virtual next-hop.

The above method for implementing the transmission path switching may be implemented with a computer program. In addition, an example of the present disclosure provides a device for implementing transmission path switching. The device includes a processor and a memory.

The processor communicates with the memory, executes instructions saved in the memory. For example, the memory includes a virtual creating instruction to be executed to create at least one virtual next-hop; and record at least one destination identity corresponding to each virtual next-hop; wherein each virtual next-hop includes one best next-hop and one second-best next-hop, a next-hop of the best path of all the at least one destination identity corresponding to each virtual next-hop is the best next-hop of the virtual next-hop, and a next-hop of the second-best path of all the at least one destination identity corresponding to each virtual next-hop is the second-best next-hop of each virtual next-hop; a path sending instruction to be executed to perform path forwarding for all the at least one destination identity corresponding to each virtual next-hop using the best next-hop of each virtual next-hop; a failure detecting instruction to be executed to perform failure detection for the best next-hop of each virtual next-hop; and a path switching instruction to be executed to perform, after detecting that the best next-hop of a virtual next-hop is failed with the failure detection, the path forwarding for all the at least one destination identity corresponding to the virtual next-hop using the second-best next-hop of the virtual next-hop.

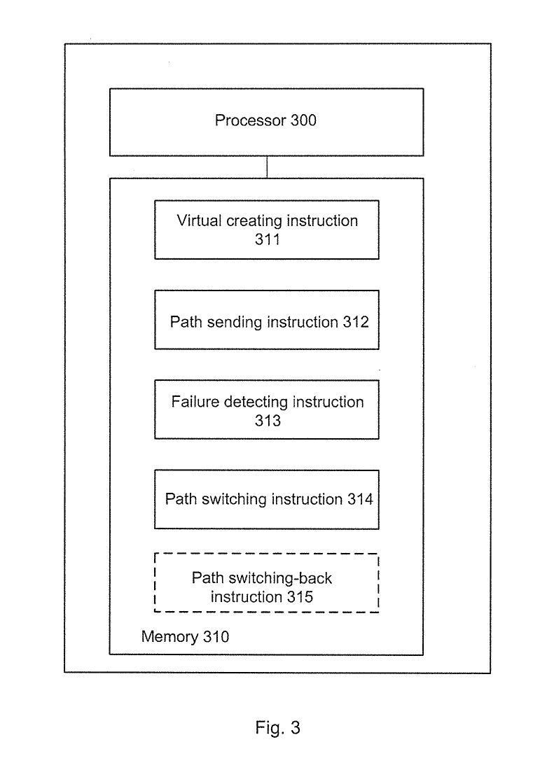

FIG. 3 is a schematic diagram illustrating structure of a device for implementing transmission path switching in accordance with an example of the present disclosure. As shown in FIG. 3, the device for implementing the transmission path switching in this example of the present disclosure includes a processor 300 and a memory 310.

The processor 300 communicates with the memory 310, and executes instructions saved in the memory 310. The memory 310 saves a virtual creating instruction 311, a path sending instruction 312, a failure detecting instruction 313 and a path switching instruction 314.

The virtual creating instruction 311 is executed to create, after the route calculation starts, at least one virtual next-hop, and record at least one destination identity corresponding to each virtual next-hop. Each virtual next-hop includes one best next-hop and one second-best next-hop. The next-hop of the best path of all the at least one destination identity corresponding to each virtual next-hop is the best next-hop of each virtual next-hop, and the next-hop of the second-best path of all the at least one destination identity corresponding to each virtual next-hop is the second-best next-hop of each virtual next-hop.

The virtual creating instruction 311 is further executed to configure a flag denoting that failure detection is to be performed for the best next-hop for the best next-hop of each virtual next-hop, and configure a flag denoting that the second-best next-hop is taken as a backup route for the second-best next-hop of each virtual next-hop. The flag denoting that the failure detection is to be performed may further include a type of the failure detection. The type of the failure detection includes the ARP detection and the BFD detection.

The path sending instruction 312 is executed to send, after the route calculation is finished, all the at least one destination identity corresponding to each virtual next-hop in the FIB and the best next-hop of each virtual next-hop to a hardware layer, so that the hardware layer performs the path forwarding for all the at least one destination identity corresponding to each virtual next-hop using the best next-hop of each virtual next-hop.

The path sending instruction 312 may be executed to send each virtual next-hop to the hardware layer, so that a corresponding relationship between all the at least one destination identity corresponding to each virtual next-hop and the best next-hop of the virtual next-hop is established in the hardware layer.

Accordingly, the hardware layer may be configured with a virtual next-hop table for saving each virtual next-hop, a destination identity table for saving all the at least one destination identity of each virtual next-hop, and a real next-hop table for saving the best next-hop or second-best next-hop of each virtual next-hop.

The failure detecting instruction 313 is executed to perform failure detection for the best next-hop of each virtual next-hop after the route calculation is finished.

The path switching instruction 314 is executed to send, when detecting that the best next-hop of any virtual next-hop is failed with the failure detection, the second-best next-hop of the virtual next-hop in the FIB to the hardware layer, so that the hardware perform the path forwarding for all the at least one destination identity corresponding to the virtual next-hop using the second-best next-hop of the virtual next-hop.

In the device shown in FIG. 3, the memory 310 may further include a path switching-back instruction 315. The path switching-back instruction 315 is executed to send, when detecting that the above failed best next-hop of the virtual next-hop becomes the available route with the failure detection, the best next-hop of the virtual next-hop in the FIB to the hardware layer, so that the hardware layer switches the route from the second-best next-hop to the best next-hop, and performs the path forwarding for all the at least one destination identity of the virtual next-hop using the best next-hop of the virtual next-hop.

The transmission path mentioned in the above device shown in FIG. 3 is a unicast route, and the destination identity is the prefix of the route. The best path is the best route, and the second-best path is the second-best route. The best route and the second-best route of each prefix are any kind of the following dynamic routes: the static routes, the OSPF protocol route, the IS-IS protocol routes, the BGP routes and the RIP routes.

In the above description, when the route calculation is finished, all the destination identities corresponding to each virtual next-hop in the FIB and the best next-hop of each virtual next-hop are sent to the hardware layer. Therefore, in the hardware layer, the path forwarding is performed for all the at least one destination identity corresponding to each virtual next-hop using the best next-hop of the virtual next-hop. In the actual application, all the at least one destination identity corresponding to each virtual next-hop and the best next-hop of each virtual next-hop may be saved in the software table. The CPU queries the software table, and performs the path forwarding for all the at least one destination identity corresponding to each virtual next-hop using the best next-hop of each virtual next-hop. The FIB may be a software table. Specifically, all the at least one destination identity corresponding to each virtual next-hop and the best next-hop of each virtual next-hop may be saved in the FIB or at least one other software table.

When it is detected that the best next-hop of any virtual next-hop is failed with the failure detection, the second-best next-hop of the virtual next-hop is saved in the software table. Therefore, the CPU queries the software table, switches the path from the best next-hop of the virtual next-hop to the second-best next-hop of the virtual next-hop, and performs the path forwarding for all the at least one destination identity corresponding to virtual next-hop using the second-best next-hop of the virtual next-hop. If all the above destination identities corresponding to each virtual next-hop and the best next-hop of each virtual next-hop are saved in the FIB, the second-best next-hop of each virtual next-hop is saved in the FIB. If all the at least one destination identity corresponding to each virtual next-hop and the best next-hop of each virtual next-hop are saved in the at least one other software table, the second-best next-hop of the virtual next-hop is saved in the at least one other software table.

If it is detected that the failed best next-hop of the virtual next-hop becomes the available route with the failure detection before the newly-triggered route calculation is finished, the best next-hop of the virtual next-hop is saved in the software table. The CPU switches the route from the second-best next-hop to the best next-hop, and performs the path forwarding for all the at least one destination identity corresponding to the virtual next-hop using the best next-hop is of the virtual next-hop. In the above description, all the destination identities corresponding to each virtual next-hop may be all the prefixes corresponding to each virtual next-hop. If all the at least one destination identity corresponding to each virtual next-hop and the best next-hop of each virtual next-hop are saved in the FIB, the best next-hop of each virtual next-hop is saved in the FIB. If all the above destination identities corresponding to each virtual next-hop and the best next-hop of each virtual next-hop are saved in at least one other software table, the best next-hop of the virtual next-hop is saved in at least one other software table.

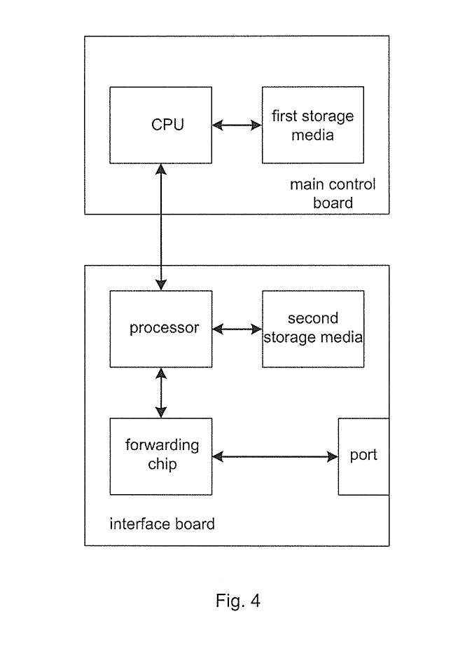

FIG. 4 is a hardware architecture which may be used for the device shown in FIG. 3. As shown in FIG. 4, the hardware architecture may include a main control board and at least one interface board. The main control board includes a CPU and a first storage media. The CPU is to implement various processing of the main control board, and may provide a protocol layer for implementing the route calculation. The first storage media saves the FIB. Each interface board includes a processor, a second storage media, a forwarding chip and a port. The processor is to implement the various processing of the interface board. The second storage media also saves the FIB which is maintained simultaneously as that of the FIB in the main control board. The forwarding chip as the hardware layer performs the path forwarding through the port of the interface board. Accordingly, the CPU of the main control board may be included in the device shown in FIG. 3. The first storage media in FIG. 4, acting as the memory 310 in FIG. 3, stores the virtual creating instruction 311, path sending instruction 312, failure detecting instruction 313, path switching instruction 314 and the path switching-back instruction 315. The CPU in FIG. 4, acting as the processor 300 in FIG. 3, executes the above instructions.

What has been described and illustrated herein are examples of the disclosure along with some variations. The terms, descriptions and figures used herein are set forth by way of illustration only and are not meant as limitations. Many variations are possible within the scope of the disclosure, is which is intended to be defined by the following claims—and their equivalents—in which all terms are meant in their broadest reasonable sense unless otherwise indicated.

What is claimed is:

1. A method for implementing transmission path switching, comprising:
creating at least one virtual next-hop;
recording at least one destination identity corresponding to each virtual next-hop, wherein each virtual next-hop comprises one best next-hop and one second-best next-hop, a next-hop of the best path of all the at least one destination identity corresponding to each virtual next-hop is the best next-hop of each virtual next-hop, and a next-hop of the second-best path of all the at least one destination identity corresponding to each virtual next-hop is the second-best next-hop of each virtual next-hop;
performing path forwarding for all the at least one destination identity corresponding to each virtual next-hop using the best next-hop of each virtual next-hop;
performing failure detection for the best next-hop of each virtual next-hop; and
performing, after detecting that the best next-hop of a virtual next-hop is failed with the failure detection, the path forwarding for all the at least one destination identity corresponding to the virtual next-hop using the second-best next-hop of the virtual next-hop.

2. The method of claim 1, wherein performing the path forwarding for all the at least one destination identity corresponding to each virtual next-hop using the best next-hop of each virtual next-hop comprises:
sending all the at least one destination identity corresponding to each virtual next-hop, and the best next-hop of each virtual next-hop to a hardware layer, to enable the hardware layer to perform the path forwarding for all the at least one destination identity corresponding to each virtual next-hop using the best next-hop of each virtual next-hop; and
performing the path forwarding for all the at least one destination identity corresponding to the virtual next-hop using the second-best next-hop of the virtual next-hop comprises:
sending the second-best next-hop of the virtual next-hop to the hardware layer, to enable the hardware layer to perform the path forwarding for all the at least one destination identity corresponding to the virtual next-hop using the second-best next-hop of the virtual next-hop.

3. The method of claim 1, wherein performing the path forwarding for all the at least one destination identity corresponding to each virtual next-hop using the best next-hop of each virtual next-hop comprises:
saving all the at least one destination identity corresponding to each virtual next-hop, and the best next-hop of each virtual next-hop in a software table, to enable a CPU to query the software table, and perform the path forwarding for all the at least one destination identity corresponding to each virtual next-hop using the best next-hop of each virtual next-hop; and
performing the path forwarding for all the at least one destination identity corresponding to the virtual next-hop using the second-best next-hop of the virtual next-hop comprises:
saving the second-best next-hop of the virtual next-hop in the software table, to enable the CPU to query the software table, and perform the path forwarding for all the at least one destination identity corresponding to the virtual next-hop using the second-best next-hop of the virtual next-hop.

4. The method of claim 1, further comprising:
configuring a flag denoting that failure detection is to be performed for the best next-hop of each virtual next-hop; and
configuring a flag denoting that the second-best next-hop is taken as a backup route for the second-best next-hop of each virtual next-hop.

5. The method of claim 4, wherein the flag denoting that the failure detection is to be performed for the best next-hop comprises: a type of the failure detection; and
the type of the failure detection comprises: Address Resolution Protocol (ARP) detection and Bidirectional Forwarding Detection (BFD) detection.

6. The method of claim 2, further comprising:
sending each virtual next-hop to the hardware layer, to establish a corresponding relationship between all the at least one destination identity corresponding to each virtual next-hop and the best next-hop of each virtual next-hop in the hardware layer.

7. The method of claim 6, wherein the hardware layer is configured with a virtual next-hop table for saving each virtual next-hop, a destination identity table for saving all the at least one destination identity corresponding to each virtual next-hop, and a real next-hop table for saving the best next-hop or the second-best next-hop of each virtual next-hop.

8. The method of claim 2, further comprising:
sending, after detecting that the failed best next-hop of the virtual next-hop becomes an available route using failure detection, the best next-hop of the virtual next-hop to the hardware layer, to enable the hardware layer to switch the route from the second-best next-hop to the best next-hop, and perform the path forwarding for all the at least one destination identity corresponding to the virtual next-hop using the best next-hop of the virtual next-hop.

9. A device for implementing transmission path switching, comprising: a processor and a memory; wherein
the processor communicates with the memory, and executes instructions saved in the memory; wherein
the instructions comprise:
a virtual creating instruction to create at least one virtual next-hop, and record at least one destination identity corresponding to each virtual next-hop, wherein each virtual next-hop comprises one best next-hop and one second-best next-hop, a next-hop of the best path of all the at least one destination identity corresponding to each virtual next-hop is the best next-hop of the virtual next-hop, and a next-hop of the second-best path of all the at least one destination identity corresponding to each virtual next-hop is the second-best next-hop of each virtual next-hop;
a path sending instruction to perform path forwarding for all the at least one destination identity corresponding to each virtual next-hop using the best next-hop of each virtual next-hop;
a failure detecting instruction to perform failure detection for the best next-hop of each virtual next-hop; and
a path switching instruction to perform, after detecting that the best next-hop of a virtual next-hop is failed with the failure detection, the path forwarding for all the at least one destination identity corresponding to the virtual next-hop using the second-best next-hop of the virtual next-hop.

10. The device of claim 9, wherein
the path sending instruction is to send all the at least one destination identity corresponding to each virtual next-hop, and the best next-hop of each virtual next-hop to a hardware layer, to enable the hardware layer to perform the path forwarding for all the at least one destination identity corresponding to each virtual next-hop using the best next-hop of each virtual next-hop; and
the path switching instruction is to send the second-best next-hop of the virtual next-hop to the hardware layer, to enable the hardware layer to perform the path forwarding for all the at least one destination identity corresponding to the virtual next-hop using the second-best next-hop of the virtual next-hop.

11. The device of claim 9, wherein
the path sending instruction is to save all the at least one destination identity corresponding to each virtual next-hop, and the best next-hop of each virtual next-hop in a software table, to enable a CPU to query the software table, and perform the path forwarding for all the at least one destination identity corresponding to each virtual next-hop using the best next-hop of each virtual next-hop; and
the path switching instruction is to save the second-best next-hop of the virtual next-hop in the software table, to enable the CPU to query the software table, and perform the path forwarding for all the at least one destination identity corresponding to the virtual next-hop using the second-best next-hop of the virtual next-hop.

12. The device of claim 9, wherein
the virtual creating instruction is to configure a flag denoting that failure detection is to be performed for the best next-hop for the best next-hop of each virtual next-hop, and configure a flag denoting that the second-best next-hop is taken as a backup route for the second-best next-hop of each virtual next-hop.

13. The device of claim 10, wherein
the path sending instruction is to send each virtual next-hop to the hardware layer, to establish a corresponding relationship between all the at least one destination identity corresponding to each virtual next-hop and the best next-hop of each virtual next-hop in the hardware layer.

14. The device of claim 13, wherein the hardware layer is configured with a virtual next-hop table for saving each virtual next-hop, a destination identity table for saving all the at least one destination identity corresponding to each virtual next-hop, and a real next-hop table for saving the best next-hop or the second-best next-hop of each virtual next-hop.

15. The device of claim 10, wherein the memory further comprises:
a path switching-back instruction to send, after detecting that the failed best next-hop of the virtual next-hop becomes an available route using failure detection, the best next-hop of the virtual next-hop to the hardware layer, to enable the hardware layer to switch the route from the second-best next-hop to the best next-hop, and perform the path forwarding for all the at least one destination identity corresponding to the virtual next-hop using the best next-hop of the virtual next-hop.
